(19) United States
(12) Patent Application Publication
(10) Pub. No.: US 2018/0125085 A1
(43) Pub. Date: May 10, 2018

(54) A METHOD OF MAKING A FERMENTED DAIRY PRODUCT

(71) Applicant: DuPont Nutrition Biosciences APS, Copenhagen K (DK)

(72) Inventors: Quill Merrill, Eudora, KS (US); Scott Bodenhausen, DeSoto, KS (US); Jessica Dunkel, Olathe, KS (US); Todd Flynn, Olathe, KS (US)

(21) Appl. No.: 15/546,409

(22) PCT Filed: Jan. 27, 2015
(86) PCT No.: PCT/US2015/013078

§ 371 Date: Jul. 26, 2017

(51) Int. Cl. A23C 19/076; A23C 9/123

(52) U.S. Cl. CPC A23C 19/0765; A23C 2260/05; A23C 9/1238

(57) ABSTRACT

A smooth fermented dairy product with smaller particles than a dairy product based on a conventional cottage cheese curd, with the texture of the Greek yogurt and a milder, less acidic flavor than Greek yogurt.

### TECHNICAL FIELD

This invention relates to a method for making a smooth fermented dairy product.

### BACKGROUND

The introduction of Greek Yogurt to the marketplace in recent years has generated much interest in high protein dairy products. The majority of Greek Yogurt is manufactured by a separation process that employs the use of separators that are cost prohibitive to most dairy manufacturers.

### SUMMARY

In one aspect, a method for producing a smooth fermented dairy product can include the steps of: (i) inoculating milk with a bacterial culture selected from the group consisting of a thermophilic culture, a mesophilic culture and a culture which is a mixture of thermophilic and mesophilic strains; (ii) fermenting the milk with the culture to reach a pH between 4.4 and 4.6 and to obtain a coagulum; (iii) cutting the coagulum obtained in step (ii) to separate the whey from the cheese curd; (iv) making further adequate steps to the curd to expel lactic acid and lactose and to remove residual whey; and (v) smoothing the curd of step (iv) to obtain a smooth fermented dairy product.

In another aspect, method for manufacturing a packaged smooth fermented dairy product, can include (i) implementing the method of producing; (ii) optionally adding a flavoring the smooth fermented dairy product obtained in step (i); and (iii) filling the product of step (i) or step (ii) in a container, to obtain a packaged smooth fermented dairy product.

In one aspect, step (iv) can include a step of draining the whey from the curd at a pH between 4.2 and 4.4. In another aspect, step (iv) can include scalding (heating) the curd, up to a temperature of 60° C. In another aspect, step (iv) can include washing the curd in water while decreasing the temperature under 10° C., such that the curd is cooled to about 4-5° C. In another aspect, the curd of step (iv) can be blended with a dressing before the smoothing step. In another aspect, step (iv) can include scalding (heating) the curd, up to a temperature of 60° C.; and draining the whey from the curd at a pH between 4.2 and 4.4. The method can further include blending the curd with a dressing.

In one embodiment, the milk in step (i) is inoculated with a culture comprising at least one Streptococcus thermophilus bacterium. In one embodiment, the milk in step (i) is not inoculated with mesophilic strains, in particular is not inoculated with Lactococcus bacteria. In another embodiment, the milk can be inoculated with mesophilic strains only (e.g., Lactococcus lactis strain). In another embodiment, the milk in step (i) can be inoculated with a culture which is a mixture of thermophilic and mesophilic strains. In one aspect, the milk in step (i) can be inoculated with a culture comprising at least one Streptococcus thermophilus bacterium and at least one Lactococcus lactis strain.

In another embodiment, the culture can be inoculated into the milk at a concentration of bacteria ranging from 10⁴ to 10¹³ cfu/ml. Preferably, the culture can be inoculated into the milk at a concentration of bacteria ranging from 10⁸ to 10¹² cfu/ml. In one aspect, the culture can be inoculated into the milk at a concentration of Streptococcus thermophilus bacteria ranging from 10⁴ to 10¹³ cfu/ml. Preferably, the culture can be inoculated into the milk at a concentration of Streptococcus thermophilus bacteria ranging from 10⁸ to 10¹² cfu/ml.

At least one of the S. thermophilus bacteria of the culture can be a fast acidifying strain.

One or more of Lactobacillus strains can be added during the method. The Lactobacillus strain can include a Lactobacillus bulgaricus strain.

In one aspect of step (ii), the curd of the dairy product can be cut at a pH between 4.4 and 4.6.

In one aspect, the protein content of the curd obtained by the method of the invention and before smoothing and/or before blending with a dressing, can be between 14% and 17%.

The smoothing step can include reducing the curd particles to a size under 300 μm. For example, all the particles (100%) in the smooth dairy product can have a size less than 300 μm. In other embodiments, 99% of total volume of the particles in the smooth dairy product is made up of particles the maximum size of which is 200 μm. In another embodiment, 95% of total volume of the particles in the smooth dairy product is made up of particles the maximum size of which is 100 μm. In another embodiment, that 90% of total volume of the particles in the smooth dairy product is made up of particles the maximum size of which is 60 μm. The reduction of curd particle size is obtained by smoothing the curd or the blend curd/dressing in a shear mill and/or a shear pump. The fermentation time in step (ii) can be from 3 to 10 hours. In one aspect, the fermentation time in step (ii) can be from 5 to 10 hours. In one aspect, the fermentation time in step (ii) can be from 3 to 5 hours. Fermenting the milk with the culture can reach a pH between 4.4 and 4.55, in particular between 4.4 and 4.5.

Draining the whey can occur without using a centrifugal separator.

A smooth fermented dairy product can have particles the size of which is less than 300 μm. In other words, the smooth fermented dairy product does not include particles having a size greater than 300 μm. In certain embodiments, the particles have a size between 1 and 300 μm. A smooth fermented dairy product can have pH between 4.10 and 4.50 and particles the size of which is less than 300 μm. A smooth fermented dairy product can have the particle the size of which is less than 300 μm with smooth and creamy texture. For example, all the particles (100%) in the smooth dairy product can have a size less than 300 μm. In other embodiments, 99% of total volume of the particles in the smooth dairy product is made up of particles the maximum size of which is 200 μm. In another embodiment, 95% of total volume of the particles in the smooth dairy product is made up of particles the maximum size of which is 100 μm. In another embodiment, that 90% of total volume of the particles in the smooth dairy product is made up of particles the maximum size of which is 60 μm. Combinations of these particle size characteristics can also be obtained.

Other aspects, embodiments, and features will be apparent from the following description, the drawings, and the claims.

### BRIEF DESCRIPTION OF THE DRAWINGS

FIG. 1 is a schematic depicting the procedure of making a smooth fermented product.

FIG. 2 is a graph depicting volume weighted particle size distributions of a Greek yogurt, a fermented smooth dairy product made with curd from the present invention, and a fermented dairy product made with conventional cottage cheese curd.

FIG. 3 is an overlay of graphs depicting volume weighted particle size distribution of fermented dairy product made with conventional cottage cheese curd.

FIG. 4 is an overlay of graphs depicting volume weighted particle size distribution of fermented smooth dairy product sample of the invention.

FIG. 5 is an overlay of graphs depicting particle volume weighted size distribution of a conventional Greek yogurt sample.

FIG. 6A is a graph depicting percentiles for particular particle size of a product based on a traditional cottage cheese curd. FIG. 6B is a graph depicting percentiles for particular particle size of a product of the invention obtained from a smoothed curd.

### DETAILED DESCRIPTION

Disclosed herein is a method of producing curd, draining the whey and processing the curd blended with various combinations of other ingredients to produce products. This method makes it possible to adapt devices used by cottage cheese manufacturers to produce a fermented dairy product with a smoothness close to the one of Greek yogurt by including a shear milling step in the existing cottage cheese process and thus low capital investment is required. Also, a smoothed fermented dairy product ensures product versatility providing an ideal vehicle for flavors, inclusions, and compositional variations in terms of fat and protein contents. This process can provide opportunities for utilizing by-products such as fines, whey, and reclaim and for cost-saving with milk prices and grades.

Previously, WO9100690, WO2011004012, WO2012145047, WO2012175752 disclosed methods of making cottage cheese, each of which is incorporated by reference in its entirety. WO9827825 disclosed a method for preparing a fromage frais having a smooth texture and more than 13% dry matter, and WO2014/095543 and WO2014/114970 disclosed a method of making a Greek yogurt using fermented lactose-reduced dairy product, each of which is incorporated by reference in its entirety.

The method described herein includes a culturing step combined with milling that imparts a smooth texture to the finished products. The pH at which curd is cut is lower than for cottage cheese, i.e. is less than 4.6, less or equals to 4.55 or less or equals to 4.5. In another aspect, the cooking temperature is higher than for cottage cheese and the holding time in the hot whey is less than for cottage cheese. This produces a soft curd that can be milled to a finer grain than typical cottage cheese curd. This can be achieved at a lower pH during cutting and draining than previous processes.

The present method uses devices for manufacturing smoothed curd, and Table 1 shows the comparison between the methods conventionally used for manufacturing cottage cheese with the one of the present invention. A traditional Greek yogurt manufacturing method was also compared.

TABLE 1
Comparison between traditional Greek yogurt, smooth fermented dairy product,
and cottage cheese.

| | Traditional greek | Smooth fermented | |
|---|---|---|---|
| | yogurt | dairy product | Traditional Cottage |
| | [=strained yogurt] | (the invention) | cheese |
| Milk | 10 minutes at | 30 seconds at | 15 seconds at 165° F./74° C. |
| treatment | 185° F./85° C. | 165° F./74° C. | |
| Fermentation | 4 hours at 106° F. | 3-4 hours, at 100° F./38° C. | 4-6 hours at 90° F./32° C. |
| | | | (mesophilic) or |
| | | | 96° F./36° C. |
| | | | (mesophilic/thermophilic) |
| Post- | at pH 4.6-4.8, skim | at pH 4.5, curd is cut | at pH 4.65-4.70, curd is |
| fermentation | milk is stirred | gentle stirring | cut into cubes |
| | centrifugation | heating at 140° F./60° C. | gentle stirring |
| | (whey/curd separation) | draining of whey at pH | heating at 130° F./54° C. |
| | cooling | 4.2-4.3 | or 140° F./60° C. |
| | packing | curd rinsed in cold | draining of whey at pH |
| | | water down to 50° F./10° C. | about 4.5 |
| | | optionally, mixture of | curd rinsed in cold |
| | | curd with dressing | water down to 50° F./10° C. |
| | | smoothing | mixture of curd with |
| | | packing | dressing (cream) |

A method for producing a smooth fermented dairy product can include the steps of (i) inoculating milk with a bacterial culture; (ii) fermenting the milk with the culture to reach a pH between 4.4 and 4.6 and to obtain a coagulum; (iii) cutting the coagulum obtained in step (ii) to separate the whey from the cheese curd; (iv) making further adequate steps to the curd to expel lactic acid and lactose and to remove residual whey; and (v) smoothing the curd of step (iv) to obtain a smooth fermented dairy product.

At step (i), the bacterial culture can be a lactic acid bacteria culture. In one aspect, said bacterial culture is selected from the group consisting of a thermophilic culture, a mesophilic culture and a culture with is a mixture of thermophilic and mesophilic strains. The term “thermophilic” and “mesophilic”, in reference to bacterial or lactic acid bacteria culture, are known in the field of dairy application and refer to cultures, used for milk fermentation, containing strains having an optimal growth temperature between 20 to 35° C. and between 35 and 45° C. respectively. In one aspect, the thermophilic culture comprises or consists of at least one (one or more) Streptococcus thermophilus strain. In one aspect, the mesophilic culture comprises or consists of at least one (one or more) Lactococcus strain(s), in particular at least one Lactococcus lactis strain(s).

In an embodiment, at step (i), the culture comprises or consists of thermophilic strain(s) and in particular can comprise one or more Streptococcus thermophilus strains or consist essentially of one or more Streptococcus thermophilus strain(s). Thus, the invention concerns a method for producing a smooth fermented dairy product which comprises the steps of (i) inoculating milk with a culture comprising at least one Streptococcus thermophilus bacterium; (ii) fermenting the milk with the culture to reach a pH between 4.4 and 4.6 and to obtain a coagulum; (iii) cutting the coagulum obtained in step (ii) to separate the whey from the cheese curd; (iv) making further adequate steps to the curd to expel lactic acid and lactose and to remove residual whey; and (v) smoothing the curd of step (iv) to obtain a smooth fermented dairy product. In an aspect, the milk is not inoculated with Lactococcus bacteria (meaning that the fermentation does not implement the use of Lactococcus bacteria). In a particular aspect, no other bacteria than Streptococcus thermophilus is used for this method. In one aspect, the thermophilic culture comprises or consists of one or more Streptococcus thermophilus strains and one or more Lactobacillus bulgaricus strain.

In another embodiment, the milk can be inoculated with mesophilic strain(s) only, such as Lactococcus lactis strain. In a particular embodiment, the milk is inoculated with at least one Lactococcus lactis subsp lactis strain and/or at least one Lactococcus lactis subsp cremoris strain.

In another embodiment, the milk in step (i) can be inoculated with a culture which is a mixture of thermophilic and mesophilic strains. In one aspect, the milk in step (i) can be inoculated with a culture comprising at least one Streptococcus thermophilus bacterium and at least one Lactococcus lactis strain (e.g., at least one Lactococcus lactis subsp lactis strain and/or at least one Lactococcus lactis subsp cremoris strain).

In one aspect, the bacterial culture as defined herein consists of bacteria only, in particular of lactic acid bacteria only.

The milk can be inoculated at a concentration of bacteria, in particular S. thermophilus, ranging from 10⁴ to 10¹³ cfu/ml, preferably from 10⁸ to 10¹² cfu/ml. At least one of the S. thermophilus bacteria of the culture can be a fast acidifying strain.

Any lactic acid bacteria, or bacterial culture, in particular any S. thermophilus strains, can be used in the present method, as long as this bacterium or these bacteria enable(s) to obtain the desired pH at the end of step (ii). Examples of cultures that can be used in the present method are disclosed in the experimental part below.

In certain aspects, the milk is cow's milk, goat's milk, sheep's milk, or any other type of suitable milk. The pasteurization should be short as compared to what is done for yogurt or Greek yogurt. If the heat treatment is shorter, the texture is smoother. If the heat treatment is long, the yield is higher because the whey proteins are denatured and are more likely to be trapped in the coagulum.

By milk, it is meant skim milk, whole milk or milk of any fat in-between, i.e., non fat to full fat (0 to 3.25%).

At step (ii), the pH can be maintained below pH 4.6, for example between 4.4 and 4.55 or between 4.4 and 4.5 to ensure to obtain a soft curd. The fermentation time in step (ii) can be from 3 to 10 hours. In one aspect, the fermentation time can be from 3 to 5 hours. In one aspect, the fermentation time can be from 5 to 10 hours.

At step (iv), the whey can be drained from the curd at a pH between 4.2 and 4.4. At this step, the curd can be heated up to 60° C. The draining can occur without using a centrifugal separator, such as by using mechanical draining. Mechanical draining can include a trenching process whereby the curd is pushed to the outer sides of the vat and then by use of screens, the whey is drained from the vat while the curd is held back and then rinsed in the vat. Draining can also be more automated whereby the curd and whey are pumped onto belts and screens. The whey escapes through the screens while the curd is retained and transported to a rinsing tank and the curd is again pumped onto belts and screens where the rinse water is separated from the curd. The curd is typically squeezed between belts to remove even more rinse water.

Step (iv) can include washing the curd in water. In one aspect, the curd is washed in water while decreasing the temperature under 10° C., such that the curd is cooled to about 4-5° C.

The curd of step (iv) can be blended with a dressing before the smoothing step. A dressing can include any fluid (dairy or non-dairy) product that helps define the end product, e.g. chocolate syrup for high protein chocolate pudding, vanilla syrup for high protein vanilla pudding, yogurt for Greek yogurt, buttermilk for quark, sour cream for high protein sour cream, fermented cream for cream cheese or Neufchatel. A dressing is not required so that the end product is very high in protein (14-17%) and very thick like cream cheese. The dressing can include a flavoring, such as, for example, chocolate, vanilla, mint, or a fruit flavoring. The flavoring can be a natural or an artificial flavoring.

In step (iv), the curd can be rinsed with water, in particular with decrease of temperature.

In an aspect, one or more Lactobacillus strain(s), in particular Lactobacillus bulgaricus strain(s), is(are) added during the method. In a particular aspect, no other bacteria than Streptococcus thermophilus and Lactobacillus strain(s) are used for this method. In a particular aspect, no other bacteria than Streptococcus thermophilus and Lactobacillus bulgaricus strain(s) are used for this method. In an aspect, Lactobacillus strain(s), in particular Lactobacillus bulgaricus, is(are) added in step (i). In an aspect, the Lactobacillus strain(s), in particular Lactobacillus bulgaricus, are added simultaneously to the one or more Streptococcus thermophilus strain(s). In an aspect, Lactobacillus strain(s), in particular Lactobacillus bulgaricus, is(are) added later than step (i) during the method.

Any of the bacteria or lactic acid bacteria added during this method, such as Streptococcus thermophilus strain(s), Lactobacillus strain(s) or Lactococcus strain(s), can be added during the method under any form, including but not limited to frozen form (such as frozen pellets) or dried form (such as freeze-dried or powder).

At step (v), the smoothing step can include reducing the curd into particles, such that all the particles (100%) in the smooth dairy product have a size less than 300 μm, in particular a size less than 250 μm, or that 100% of total volume of the particles in the smooth dairy product is made up of particles the maximum size of which is 300 μm, in particular the maximum size of which is 250 μm.

In an embodiment, at step (v), the smoothing step can include reducing the curd into particles, such that 99% of total volume of the particles in the smooth dairy product is made up of particles the maximum size of which is 200 μm, in particular the maximum size of which is 150 μm.

In an embodiment, at step (v), the smoothing step can include reducing the curd into particles, such that more than 95% of total volume of the particles in the smooth dairy product is made up of particles the maximum size of which is 100 μm, in particular the maximum size of which is 90 μm, in particular the maximum size of which is 80 μm, in particular the maximum size of which is 70 μm.

In an embodiment, at step (v), the smoothing step can include reducing the curd into particles, such that more than 90% of total volume of the particles in the smooth dairy product is made up of particles the maximum size of which is 60 μm, in particular the maximum size of which is 50 μm.

In an embodiment, at step (v), the smoothing step can include reducing the curd into particles, such that at least two, at least three or all the following parameters are fulfilled:
1) all the particles (100%) in the smooth dairy product have a size less than 300 μm, in particular a size less than 250 μm or 100% of total volume of the particles in the smooth dairy product is made up of particles the maximum size of which is 300 μm, in particular the maximum size of which is 250 μm;
2) more than 99% of total volume of the particles in the smooth dairy product is made up of particles the maximum size of which is 200 μm, in particular the maximum size of which is 150 μm;
3) more than 95% of total volume of the particles in the smooth dairy product is made up of particles the maximum size of which is 100 μm, in particular the maximum size of which is 90 μm, in particular the maximum size of which is 80 μm, in particular the maximum size of which is 70 μm; and/or
4) more than 90% of total volume of the particles in the smooth dairy product is made up of particles the maximum size of which is 60 μm, in particular the maximum size of which is 50 μm.

The reduction of curd particle size can be obtained by smoothing the curd or the blend curd/dressing in a shear mill and/or a shear pump. Many other apparatus can be used to reduce particle size. The examples below show particle size achieved using a shear mill.

Two main steps to obtain smooth fermented products as compared to cottage cheese manufacturing are (1) cutting coagulum at a pH no higher than 4.5 or 4.6; and (2) smoothing the final curd, optionally after blending, in a shear mill. A Boston Shearmill and/or a Boston Shearpump (Admix) can be used for smoothing the curd or the blend curd/dressing. See, admix.com/boston-shearmill-inline-high-shear-mixer, admix.com/pdfs/resourcelibrary-brochures-bostonshearmill.pdf and www.admix.com/pdfs/resourcelibrary-brochures-bostonshearpump.pdf, each of which is incorporated by reference in its entirety.

It is believed that the softer curd is a result of less casein remaining in the curd under pH 4.6. Indeed, casein is the least soluble at its isoelectric point (pH 4.6) and that is where curd is fully formed in the traditional cottage cheese making process. In contrast, as the pH drifts above or below the isoelectric point, the casein becomes more soluble and is less likely to remain in curd form. The method described herein allows the pH to drop below 4.6 before cutting and the pH continues to drop during the process due to the activity of the cultures. By the time the curd is cooked and washed, the pH is much lower than 4.6 and the curd is soft and breaks apart with ease compared to traditional cottage cheese curd. This is why product made with the curd for smoothing (pH far below the isoelectric point) is much smoother than curd made by the traditional process (pH closer to the isoelectric point).

When curd from a typical process such as dry curd cottage cheese is used, the resulting products do not have a smooth texture but have a sandy or grainy texture. Previously, to make cottage cheese product with a smoother texture, blends with different ratios of cottage cheese curd to buttermilk have been tried. When 8 parts curd to 5 parts buttermilk was used, the blend was too thick to pump out of the vessel. When the ratio was changed to include more buttermilk (liquid portion), the blend was more fluid so that it would pump more easily from the vessel. However, changing this ratio did not improve smoothness.

The invention also relates to a method for manufacturing a packaged smooth fermented dairy product, comprising, after implementing the method of producing a smooth fermented dairy product as described here, to fill the product in a container, to obtain a packaged smooth fermented dairy product. In an aspect, before filling flavoring is added as a part of the smooth fermented dairy product.

Finally, the invention is also directed to a smooth fermented dairy product obtained by the method described herein. In one aspect, the smooth fermented dairy product has a pH between 4.10 and 4.50 and has at least one, at least two, at least three or all the following:

1) all the particles (100%) in the smooth dairy product have a size less than 300 μm, in particular a size less than 250 μm or 100% of total volume of the particles in the smooth dairy product is made up of particles the maximum size of which is 300 μm, in particular the maximum size of which is 250 μm;

2) more than 99% of total volume of the particles in the smooth dairy product is made up of particles the maximum size of which is 200 μm, in particular the maximum size of which is 150 μm;

3) more than 95% of total volume of the particles in the smooth dairy product is made up of particles the maximum size of which is 100 μm, in particular the maximum size of which is 90 μm, in particular the maximum size of which is 80 μm, in particular the maximum size of which is 70 μm; and/or

4) more than 90% of total volume of the particles in the smooth dairy product is made up of particles the maximum size of which is 60 μm, in particular the maximum size of which is 50 μm.

In another aspect, the smooth fermented dairy product has particles size and percentage in the final product as described above, with smooth and creamy texture.

In a preferred embodiment, the smooth fermented dairy product is not a traditional greek yogurt (such as obtained by the method described in Table 1).

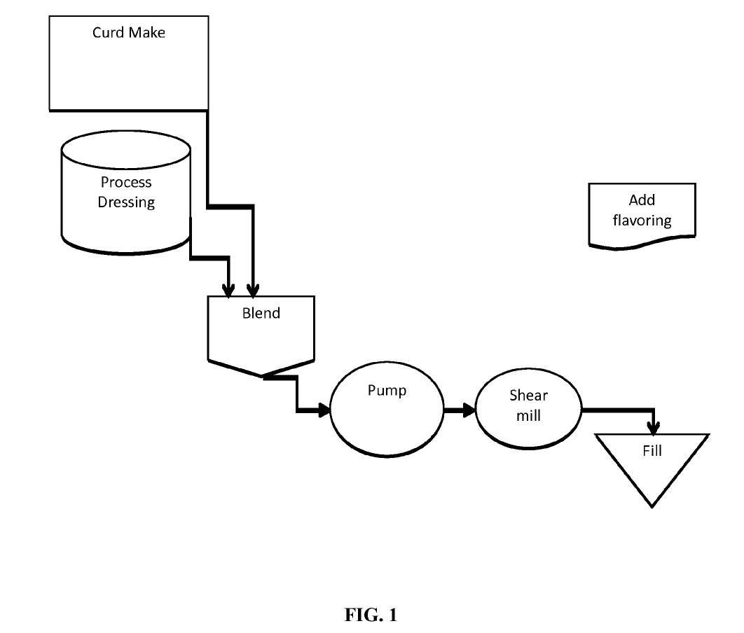

Disclosed herein is a method of achieving a smooth texture by combining the unique culturing and milling steps, which overcomes prior limitations. FIG. 1 shows a schematic of this method; (1) curd is made on standard cottage cheese equipment using the unique method of the invention, (2) optionally dressing is processed High Temperature Short Time or Ultra High Temperature, (3) optionally blending in a typical cottage cheese curd and dressing blender, (4) pumping the curd or the blend to a shear mill, (5) milling the pumped curd or blend for smooth texture, (6) optionally flavoring is added as part of the dressing process, and (7) filling the product in a container.

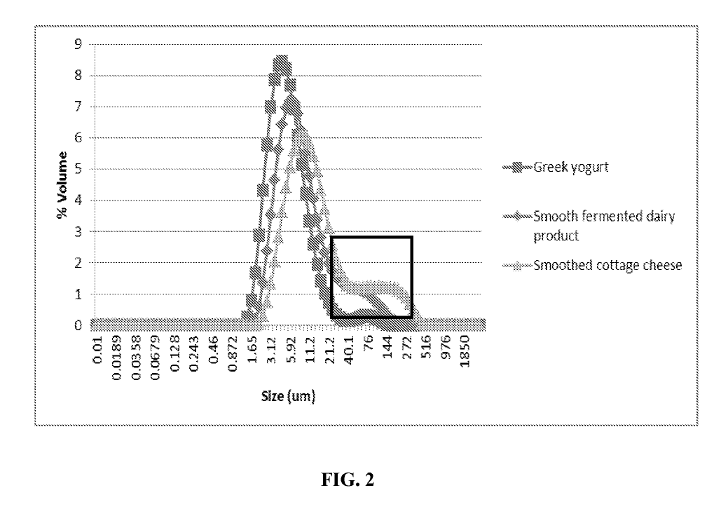

To demonstrate that the key to a smooth texture is a combination of the unique culturing and milling steps, curd from typical cottage cheese manufacturing has been compared to curd using the method of the invention. FIG. 2 shows the volume size distribution of the grainy or sandy particles in the finished products of a representative Greek yogurt, a smooth fermented dairy product made by the method described herein, and a dairy product made from a typical cottage cheese curd. The only differences between the curd of this process and cottage cheese manufacturing are the cultures used and the pH where the curd has been cut.

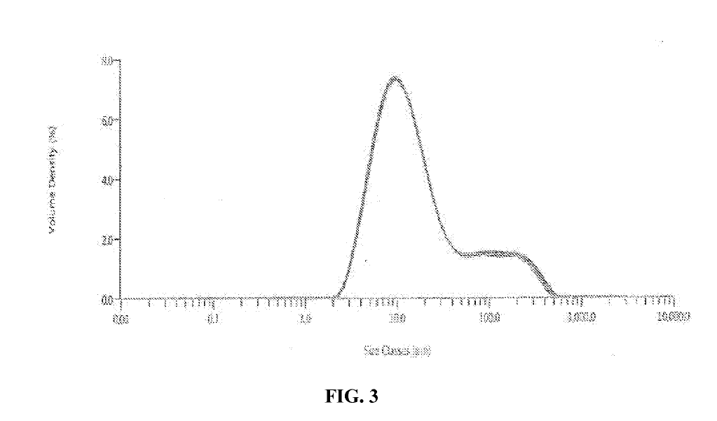

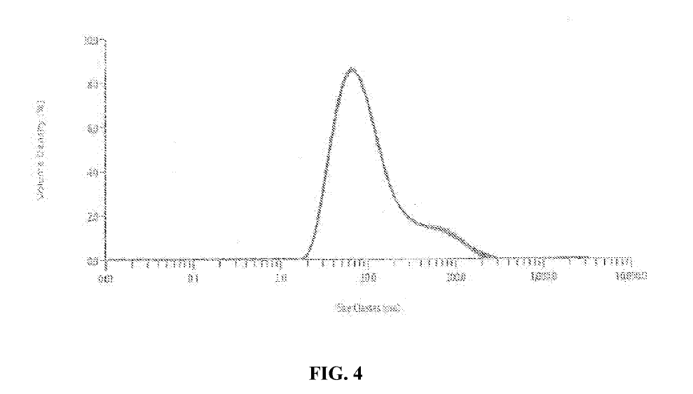

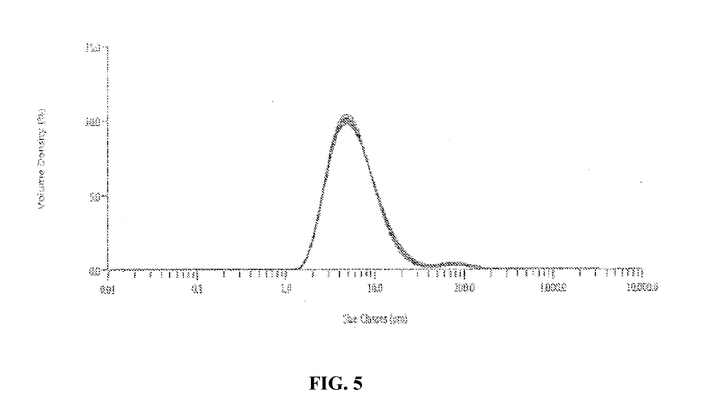

The size of the particles of the product described herein is smaller than the size of the particles of the dairy product made from a traditional cottage cheese curd, and is quite close from a representative Greek yogurt (Table 2). FIG. 3, FIG. 4, and FIG. 5 show the volume weighted particle size distributions of samples of cottage cheese-based product, smooth fermented dairy product, and Greek yogurt, respectively. The distributions were very consistent within the same group of products.

The most important differences are outlined herein:
Greek yogurt has few particles above 100 μm (about 0.3% of volume). In contrast, the dairy product made from a cottage cheese curd has about 10% of volume made up of particles with a size above 100 μm. Interestingly, by the process described herein, only 2% of total volume of the particles in the smooth dairy product is made up of particles with a size above 100 μm.
regarding particles of large size, the dairy product made from a cottage cheese curd has particles the size of which is as large as 400 μm. It is noteworthy that in the smooth dairy product obtained by the process of the invention, there is no particle the size of which is above 250 μm; moreover, more than 99% of total volume of the particles in the smooth dairy product is made up of particles with a maximum size of 150 μm.
finally, an interesting size regarding particle is 60 μm. Indeed, 60 μm seems to be a cutoff for particle size that can be detected in the mouth by trained panelists, meaning that the fewer the size of the particles over 60 μm, the smoother the product. Thus, 94.42% of total volume of the particles in the smooth dairy product is made up of particles with a maximum size of 58.9 μm, whereas only 84.45% of total volume of the particles in a product obtained using a traditional cottage cheese curd is made up of particles with a maximum size of 58.9 μm (i.e., a difference of 10 percentage points).

As mentioned above, the low size of particles obtained with this process is due to the fact that the curd has been cut at a pH under 4.6 (preferably under 4.55 or under 4.5). This is thus the combination of this cutting at low pH and use of a shear mill that enables to obtain a product with smoothness comparable to Greek yogurt.

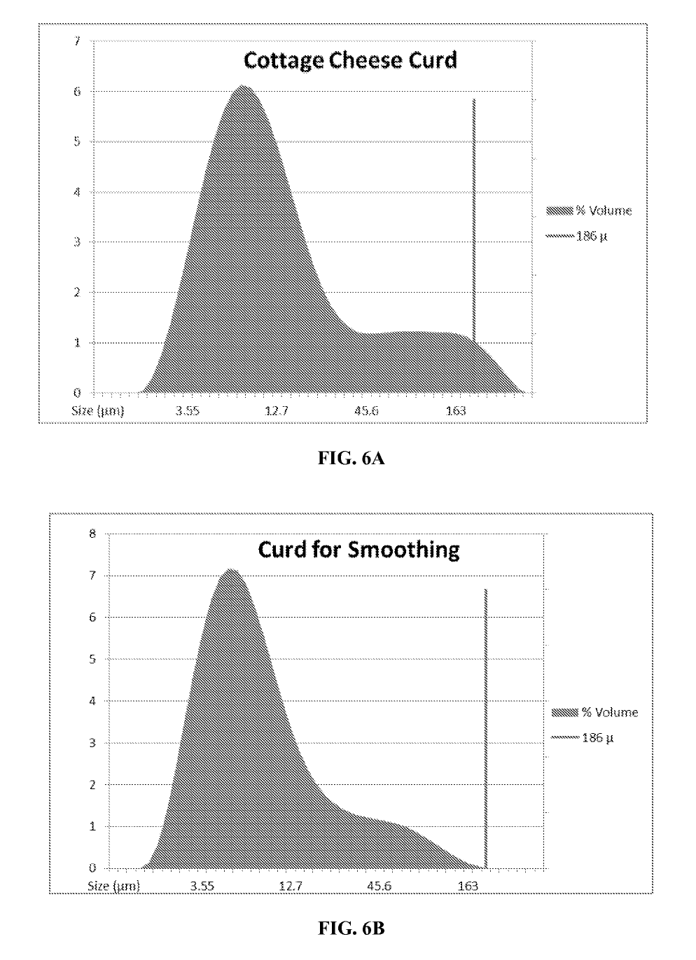

FIGS. 6A-6B are graphs that illustrate percentiles for particular particle size. Each graph is a reproduction of the graph provided by software (Malvern) produced from the raw data. Included in the graphs for both smoothed curd products is a vertical line depicting the percentile for 186 microns which was 99.94% for the product made with curd for smoothing and 95.38% for the product made with cottage cheese curd.

Moreover, since the process includes cooking the curd and rinsing the curd several times, more lactose and lactic acid can be eliminated and less lactic acid bacteria remain in the final product as compared to the Greek yogurt production. Therefore, the product is milder than traditional Greek yogurt. This can be checked by measuring the pH of the final product after storage (Table 3).

TABLE 3
pH and ΔpH of Greek yogurt, smooth fermented
dairy product of the invention and dairy product
made from conventional cottage cheese curd.

| | pH at day 1 | pH at day 60 | ΔpH |
|---|---|---|---|
| Greek yogurt | 4.65 | 4.09 | 0.56 |
| Smooth fermented dairy product | 4.44 | 4.20 | 0.22 |
| Dairy product from conventional | 4.54 | 4.34 | 0.20 |
| cottage cheese curd | | | |

As shown in Table 3, the method of the present invention enables to reduce the acidification during storage (i.e., between packaging and consumption) (delta pH is close to 0.6 for Greek yogurt, and 0.2 for the smooth fermented dairy product and dairy product from cottage cheese curd). This is explained by the fact that in the disclosed method, the curd is rinsed several times in cold water so that some of the bacterial strains are removed from the final product (same as in cottage cheese). In contrast, in traditional Greek yogurt, bacterial strains stay in the final product contributing to the acidification. Thus, the pH of the smooth fermented dairy product after storage was not as low as a Greek yogurt product, meaning that the final product after storage is less acidic. In summary, this method can produce a smooth fermented dairy product having the texture of the Greek yogurt with smaller particles than a dairy product obtained from cottage cheese curd, and with a similar acidity as the smooth product made with cottage cheese curd. The properties of the dairy product can depend on whether the dressing is fermented or not.

### EXAMPLES

### Procedure of Making a Smooth Fermented Dairy Product

a) Manufacture of a Smooth Curd (Thermophilic Culture)

Twenty-six gallons skim milk was pasteurized at 165° F. for 30 seconds and filled in a vessel where the temperature was adjusted to 102° F. The skim milk was inoculated with 22 grams of Choozit Swift culture (from DuPont Danisco), a Streptococcus thermophilus culture, without adding calcium or rennet. The curd was cut at pH 4.50 with about 3.5 hour set and healed for 30 minutes so that pH should be down to 4.5 or lower. The curd was then cooked by 2° F. every 10 minutes up to 106° F. while stirring very gently and steamed up to cook rapidly to 135° F. (about 1° F. per minute). The curd temperature should not rise above 140° F. and the curd should not be held in hot whey any longer than 10 minutes. The curd was gently pushed to back of the vessel, and a screen was placed in front of drain. Hot whey was drained so that most of the whey should be gone but not so much that the curd mats. The final whey pH target should be 4.3-4.4. Cold water (35-40° F.) treated with 10 ppm chlorine and pH of 5.0 was added to fill the vessel up again and the curd was stirred to cool. The curd was drained again and the rinse step was repeated with treated cold water (35-40° F.) and drained again with a target temperature less than 50° F. The curd was pushed to the back of the vessel to allow to drain before using for smoothing and stored in a cooler. The curd protein content was measured and kept draining until the protein target was reached (15%+/−0.5%).

b) Manufacture of a Yogurt-Based Dressing

The yogurt-based dressing includes 83.00% skim milk (0.10% fat), 12.50% whole milk (3.25% fat), 1.50% non fat dry milk, and 3.00% Grindsted® SSD 6760 Stabilizer. The yogurt dressing was made by blending powders with the milk portion to hydrate (5 minutes), HTST at 185° F., 30 second hold, homogenization at 1000/500 psi. The set temperature was 110° F. Yo-Mix™ 2651, HOLDBAC™ YM-C Plus cultures were used and the break pH was 4.60.

Grindsted® SSD 6760 Stabilizer provides good viscosity for curd suspension before smoothing and syneresis control in the finished product (ingredients: corn starch and pectin).

YO-Mix™ 2651 is a yogurt culture that provides a mild yogurt flavor in fermented yogurt dressing that is applied to curd for smoothing to make high protein products like Greek Yogurt.

HOLDBAC™ YM-C Plus protective culture provides inhibition of yeast and mold throughout the process and in the finished product. HOLDBAC™ is best added to the cultured portion for production of metabolites that inhibit yeast and mold.

The final composition of yogurt dressing includes less than 0.50% fat, 3.40% protein, and 13.50% total solids. The dressings were held at 40° F.

c) Blending and Smoothing Steps

The smooth curd obtained in a) was blended with the yogurt-based dressing obtained in step b) (55% smooth curd with 45% dressing).

The blend was pumped to a shear pump with a PD pump with a setting of PD pump at 3 gpm, a shear pump at 3000 rpm with medium, fine and ultra-fine heads and a back pressure valve on exit. Back pressure setting should be about 40 psi. A pressure gauge was included between the shear pump and the PD pump to monitor pressure as well. A flavor or a seasoning was added if desired. The final product was packaged and refrigerated.

### Procedure of Making a Dairy Product Based on Traditional Cottage Cheese Curd

a) Manufacture of a Traditional Cottage Cheese Curd

Skim milk was prepared for culturing and pasteurized at the lowest temperature during shortest time necessary. The skim milk was heated to 90° F. and inoculated with 0.8 grams of a DuPont Choozit™ MC (mesophilic culture) per gallon (calcium chloride or rennet optional). The curd was cut at pH 4.65-4.70 with about 5-6 hour set and healed for 30 minutes pH was checked.

If pH is not down to 4.5, food grade acid was added to bring the pH down to 4.5 while stirring very gently. The curd was cooked by 2° F. every 10 minutes up to 105° F. Very little stirring is necessary and should be very gentle. The temperature was raised to cook rapidly to 128° F. (MC) or 138° F. (MCT) about 1° F. every minute. The curd was held at the temperature for about 30 minutes until curd is firm enough (bounces off floor or springs back when pressed in your hand when cooled to 45° F.). Hot whey was drained to where curd is showing through the whey but not so much that the curd mats. Final whey pH target was 4.5. Ice water treated with 10 ppm chlorine and pH of 5.0 was added to fill vessel up again and stirred to cool the curd. The curd was drained again and rinse step was repeated with treated ice water. The curd was drained again with target temperature less than 50 F and allowed to drain before adding dressing.

The manufacture of a dressing, blending step and smoothing step are identical to steps b) and c) described above in the procedure of making a smooth fermented dairy product.

### Procedure of Making a Greek Yogurt

Traditional Greek yogurt (strained) was produced by the use of Yo-Mix™ Culture for acidification and HOLDBAC™ YM-C Plus Culture for protection against yeast and mold. YO-Mix™ 2651 is a yogurt culture that provides a mild, traditional Greek Yogurt flavor to strained Greek Yogurt with the added benefit of probiotics. HOLDBAC™ YM-C Plus protective culture provides inhibition of yeast and mold throughout the process and in the finished product.

Skim milk was used as the starting ingredient with High Temperature Short Time (HTST) at 190° F., 7 minute hold, homogenization at 1500/500 psi, and set temperature 106° F. Yo-Mix™ 2651 and HOLDBAC™ YM-C Plus were used with the break pH at 4.60 to 4.65. The cultured mix was heated to 110° F., and run through separator (GEA Westfalia KNA 3-06-076) target 10% protein upon exit. The mix was smoothed through a back pressure valve and cooled to 60° F. The final product was packaged and refrigerated. The composition of the final product included less than 0.50% fat, 9-10% protein, and 15-16% total solids.

### Particle Size Distribution Measurement

Samples were diluted by taking 1 g of sample (curd obtained following the method of the invention, a traditional cottage cheese curd and a Greek yogurt) to 5 g of DI water and hand stirred. Then, samples were tested, on a Malvern Mastersizer 3000 Hydro MV, using the SOP for emulsions which is measured at a refractive index of 1.65 and an absorption index of 0.00. A volume weighted particle size distribution was obtained.

Volume Weighted Distributions

Static light scattering techniques such as laser diffraction will give a volume weighted distribution. Here the contribution of each particle in the distribution relates to the volume of that particle, i.e. the relative contribution will be proportional to (size)³. This is often extremely useful as the distribution represents the composition of the sample in terms of its volume/mass.

Percentiles

For volume weighted particle size distributions, such as those measured by laser diffraction, it is often convenient to report parameters based upon the maximum particle size for a given percentage volume of the sample.

Percentiles are defined as XaB where:

X=parameter, usually D for diameter

a=distribution weighting, e.g. n for number, v for volume, i for intensity

B=percentage of sample below this particle size e.g. 50%, sometimes written as a decimal fraction i.e. 0.5.

### Measurement of pH of Final Product

Samples were packaged and stored in the refrigerator at 4° C. At day 1, each sample was removed from the refrigerator and pH was measured at 4° C. with pH meter. At day 60, each sample was removed from the refrigerator and pH was measured at 4° C. with pH meter. The difference of pH between day 60 and day 1 was calculated (ΔpH). The pH meter was Accumet AP72 and pH Probe on the meter was Accumet 13-620-AP55 (dual pH measurement and temperature adjustment).

### Other Examples of Smooth Products

### Smoothed Curd Yogurt

A low-fat yogurt formula including 1.00% fat, 10.00% Milk Solids Non Fat (MSNF) (3.4% protein), 3.00% Grindsted Yogurt 6760 stabilizer, culture with preferred Yo-Mix™ culture, and protective culture HOLDBAC™ YM-C (from DuPont-Danisco) is prepared.

A blend of 45% of this low-fat yogurt and 55% dry curd (15.15% protein) obtained by the present invention is prepared and the blend is smoothed. The finished product is fat-free with 10% protein. The ingredients in the finished product can include cultured pasteurized skim milk and cream, native corn starch and pectin. A 2% product can be prepared by blending in cultured cream prior to milling. A strawberry product can be prepared by adding 20% fruit prep after milling.

### Smoothed Curd Buttermilk

A low-fat buttermilk formula including 1.00% fat, 10.00% MSNF (3.4% protein), 3.00% yogurt 6760 stabilizer, culture with Choozit™ culture, and protective culture HOLDBAC™ YM-C (from DuPont-Danisco) is prepared.

4A blend of 45% of this low-fat buttermilk and 55% dry curd (15.15% protein) obtained by the present invention is prepared and the blend is smoothed. The finished product is fat-free with 10% protein. The ingredients in the finished product can include cultured pasteurized skim milk and cream, native corn starch and pectin. A 2% or 4% product can be prepared by blending in cultured cream prior to milling.

### Smoothed Curd Cream Cheese

A cultured cream formula including 40.00% fat, 5.00% MSNF (1.7% protein), culture with Choozit™ 1001 B, and protective culture HOLDBAC™ YM-C (from DuPont-Danisco) is prepared.

A blend of 60% of this cultured cream and 40% dry curd (14.0% protein, 12% fat) obtained by the present invention is prepared and the blend is smoothed. Then the mixture is heated to 185° F., and LBG (Locust Bean Gum) and salt are added and homogenized at 3000 psi single stage. The product is packaged and cooled or alternatively LBG can be added to the cream portion. The finished product has 6.5% protein with 33% fat. The target fat 33% is achieved by using whole milk to make the curd. The ingredients in the finished product can include cultured pasteurized cream, milk, salt and locust bean gum.

### Smooth Curd Chocolate Pudding

A chocolate dressing formula including 6% fat, 4.75% MSNF (1.6% protein), 25% sugar, 5% cocoa powder, 1.00% Hi Dress Stabilizer 6682, 0.35% MG 430 is prepared.

A blend of 45% of this chocolate dressing and 55% dry curd (15.5% protein) obtained by the present invention is prepared and the blend is smoothed. The ingredients in the finished product can include cultured pasteurized skim milk, sugar, cream, cocoa power, guar gum, xanthan gum, carrageenan, and locust bean gum. The nutrition facts include 150 calories per serving (30 calories from fat) with 3 g total fat (5%), 15 mg cholesterol (5%), 45 mg sodium (2%), 22 g total carbohydrate (7%), 9 g protein, 2% vitamin A, 10% calcium, and 4% iron for a 100 gram serving.

### Smoothed Curd Protein Base for Smoothie

A blend of 20% low-fat buttermilk (or yogurt) [prepared as described herein], 55% dry curd (16.17% protein) obtained by the present invention, 25% pectin slurry (3% GRINDSTED® AMD 783 pectin in water) is prepared and the blend is smoothed to a smooth consistency. The finished product has 9.5% protein.

The smoothie can include 40% protein base, 30% pulp free orange juice, 25% water, 5% sugar, and mango flavor added to taste, which are processed on UHT, packaged and refrigerated.

Example of Smooth Curd Obtained by the Method of the Invention with a Mesophilic Culture

Twenty-six gallons milk was pasteurized at 165° F. for 30 seconds and filled in a vessel where the temperature was adjusted to 92° F. The skim milk was inoculated with 22 grams of Choozit™ MC culture, with optional rennet addition. The curd was cut at pH 4.50 with about 8-10 hour set and healed for 30 minutes. The curd was then cooked by 2° F. every 10 minutes up to 105° F. while stirring very gently and steamed up to cook rapidly to 128° F. (about 1° F. per minute). The curd should not be held longer than about 10 minutes. The curd was gently pushed to back of the vessel, and a screen was placed in front of drain. Hot whey was drained so that most of the whey should be gone but not so much that the curd mats. The final whey pH target should be 4.3-4.4. Cold water (35-40° F.) treated with 10 ppm chlorine and pH of 5.0 was added to fill the vessel up again and the curd was stirred to cool. The curd was drained again and the rinse step was repeated with treated cold water (35-40° F.) and drained again with a target temperature less than 55° F. The curd was pushed to the back of the vessel to allow to drain before adding dressing.

A dressing for the curd was prepared. Each dressing was blended with the curd at a ratio of about 55% curd with 45% dressing. The blended mixture was milled to smooth. The final product was packaged and refrigerated.

Other embodiments are within the scope of the following claims.

1. A method for producing a smooth fermented dairy product, comprising the steps of:
(i) inoculating milk with a bacterial culture selected from the group consisting of a thermophilic strain culture, a mesophilic strain culture and a culture which is a mixture of thermophilic and mesophilic strains;
(ii) fermenting the milk with said bacterial culture to reach a pH of between 4.4 and 4.6 and to obtain a coagulum comprising cheese curd and whey;
(iii) cutting the coagulum obtained in step (ii) to separate whey from the cheese curd;
(iv) expelling lactic acid and lactose and removing residual whey from the curd; and
(v) smoothing the curd of step (iv) to obtain a smooth fermented dairy product.

2. The method of claim 1, wherein the bacterial culture in step (i) comprises at least one Streptococcus thermophilus bacterium.

3. The method of claim 1 wherein step (iv) comprises draining whey from the curd at a pH of between 4.2 and 4.4.

4. The method of claim 1, wherein step (iv) comprises scalding (heating) the curd without allowing the temperature to rise above 60° C.

5. The method of claim 1, wherein step (iv) comprises washing the curd in water.

6. The method of claim 1, wherein the curd of step (iv) is blended with a dressing before the smoothing step.

7. The method of claim 1, wherein step (iv) includes:
scalding (heating) the curd without allowing the temperature of to rise above 60° C.; and
draining whey from the curd at a pH of between 4.2 and 4.4.

8. The method of claim 7, further comprising washing the curd of step (iv) in water while decreasing the temperature of the curd to about 4-5° C.

9. The method of claim 8, further comprising blending the curd of step (iv) with a dressing.

10. The method of claim 1, wherein said bacterial culture is inoculated into the milk at a concentration ranging from 10⁴ to 10¹³ cfu/ml.

11. The method of claim 1, wherein said bacterial culture is inoculated into the milk at a concentration ranging from 10⁸ to 10¹² cfu/ml.

12. The method of claim 1, wherein the bacterial culture in step (i) comprises at least one S. thermophilus bacteria that is a fast acidifying strain.

13. The method of claim 1 wherein one or more of Lactobacillus strains is added during the method.

14. The method of claim 13, wherein at least one of the one or more Lactobacillus strains is a Lactobacillus bulgaricus strain.

15. The method of claim 1, wherein the smoothing step comprises reducing the curd into particles, such that all the particles (100%) in the smooth dairy product have a size of less than 300 μm.

16. The method of claim 1, wherein the smoothing step comprises reducing the curd into particles, such that at least 99% of the total volume of the particles in the smooth dairy product is made up of particles having a size of no greater than 200 μm.

17. The method of claim 1, wherein the smoothing step comprises reducing the curd into particles, such that at least 95% of total volume of the particles in the smooth dairy product is made up of particles having a size of no greater than 100 μm.

18. The method of claim 1, wherein the smoothing step comprises reducing the curd into particles, such that at least 90% of total volume of the particles in the smooth dairy product is made up of particles having a size of no greater than 60 μm.

19. The method of claim 15, wherein said reduction of curd particle size is obtained by smoothing the curd or a blend of the curd and a dressing in a shear mill and/or a shear pump.

20. The method of claim 1, wherein the fermentation in step (ii) has a fermentation time of from 3 to 10 hours.

21. The method of claim 1, wherein the pH reached during the fermentation of step (ii) is under 4.55.

22. The method of claim 1, wherein the pH reached during the fermentation of step (ii) is between 4.4 and 4.5.

23. The method of claim 3, wherein step (iv) comprises draining whey without using a centrifugal separator.

24. A method for manufacturing a packaged smooth fermented dairy product, comprising:
(a) implementing the method of claim 1 to obtain a smooth fermented dairy product;
(b) optionally adding a flavoring to the smooth fermented dairy product obtained in step (a); and
(c) filling the product of step (a) or step (b) into a container to obtain a packaged smooth fermented dairy product.

25. A smooth fermented dairy product obtained by the method of claim 1.

26. A smooth fermented dairy product, wherein the product:
has a pH of between 4.10 and 4.50; and
comprises particles, all of which are under 300 μm in size.

27. A fermented dairy product having a smooth and creamy texture, wherein the product comprises particles, all of which are under 300 μm in size.

28. The product of claim 26, wherein at least 99% of total volume of the particles in the product have a size of no greater than 200 μm.

29. The product of claim 26, wherein at least 99% of total volume of the particles in the product have a size of no greater than 150 μm.

30. The product of claim 26, wherein at least 95% of total volume of the particles in the product have a size of no greater than 100 μm.

31. The product of claim 26, wherein at least 95% of total volume of the particles in the product have a size of no greater than 90 μm.

32. The product of claim 26, wherein at least 95% of total volume of the particles in the product have a size of no greater than 80 μm.

33. The product of claim 26, wherein at least 95% of total volume of the particles in the product have a size of no greater than 70 μm.

34. The product of claim 26, wherein at least 90% of total volume of the particles in the product have a size of no greater than 60 μm.

35. The product of claim 26, wherein at least 90% of total volume of the particles in the product have a size of no greater than 50 μm.

36. The product of claim 26, wherein the product has at least one of (1)-(4):
(1) all its particles (100%) have a size less than 250 μm;
(2) at least 99% of the total volume of the particles in the product have a size of no greater than 200 μm;
(3) at least 95% of the total volume of the particles in the product have a size of no greater than 100 μm; and/or
(4) at least 90% of the total volume of the particles in the product have a size of no greater than 60 μm.

37. The method of claim 5, wherein the washing decreases the temperature of the curd to under 10° C.
